(19) United States
(12) Patent Application Publication
(10) Pub. No.: US 2009/0252004 A1
(43) Pub. Date: Oct. 8, 2009

(54) LIGHT BEAM OUTPUT CONTROL DEVICE, LIGHT BEAM EMISSION CONTROL PROGRAM, AND RECORDING MEDIUM ON WHICH LIGHT BEAM EMISSION CONTROL PROGRAM IS RECORDED

(75) Inventors: Junichi Furukawa, Saitama (JP); Kiyoshi Tateishi, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/066,197

(22) PCT Filed: Sep. 4, 2006
(86) PCT No.: PCT/JP2006/317473

§ 371 Date: May 7, 2008

(30) Foreign Application Priority Data
Sep. 9, 2005 (JP) 2005-262226

(51) Int. Cl. G11B 19/00; G01J 1/32

(52) U.S. Cl. 369/47.5; 250/205; G9B/7

(57) ABSTRACT

A light beam output control device is provided, which can adequately perform a negative feedback control for different light beams.

An optical pickup device 100 calculates an error between a detection voltage, a laser, and a target value of each kind of the detected laser beams. If the calculated error is not in a predetermined range for each kind of the laser beams, the optical pickup device makes each kind of the laser beams correspond to the error, changes a correction amount of the error when a negative feedback control is performed, and corrects the error on the basis of the correction amount corresponding to each kind of the laser beams, thereby performing a negative feedback control.

### TECHNICAL FIELD

The present invention relates to a laser output control device that controls output of a light beam such as a semiconductor laser.

### BACKGROUND ART

As a CD (Compact Disc) or a DVD disc (Digital Versatile Disc) has been widely used and a recording/reproducing device used to reproduce information on these optical recording media has been being developed in recent years, there are demands for a technology reliably for recording data on the optical recording media, and a technology reliably for reproducing recorded data from the optical recording media.

In particular, in an optical pickup device for emitting a light beam such as a laser beam onto an optical disc when the recording/reproduction of data is performed, an APC (Automatic Power Control) method, which detects a part of an emitted light beam and performs a negative feedback control on the basis of the detected light beam, has recently been used as a method of performing an output control of the light beam.

### DISCLOSURE OF THE INVENTION

### Problem that the Invention is to Solve

However, in the optical pickup device using the above-mentioned APC method, a negative feedback control may be not adequately performed when the recording/reproduction of data is performed using different light beams.

That is, when light beams corresponding to different formats, such as an infrared laser beam, a red laser beam and a blue laser beam are emitted onto optical discs having different formats, such as a CD, a DVD, and a BD (blue-ray disc), current-light intensity level characteristics (herein after, referred to as “IP characteristics”) vary for every laser diode corresponding light beams in the optical pickup device using the APC method. For this reason, a wide adjustment range may be required for adjusting the outputs of the several kinds of laser diodes. Therefore, for example, when the outputs of the laser diodes are adjusted over a wide range by a single controller, it may not be possible to adequately control the outputs of each of the laser diodes.

The present invention has been made to solve the above-mentioned problem, and it is an object of the present invention to provide a light beam output control device that can adequately perform a negative feedback control for different light beams.

### Problems to be Solved by the Invention

In order to solve the above problem, the invention according to claim 1 relates to a light beam output control device, which performs an emission control of different kinds of light beams, the device comprising:

emission means for emitting the different kinds of light beams;

beam detection means for detecting an output intensity level of the light beam emitted from the emission means;

error detection means for detecting an error between the detected output intensity level of the light beam and a target value;

correction means for deciding an offset amount on the basis of the error and a correction amount corresponding to each kind of the light beams; and

output control means for controlling the output intensity level of the light beams emitted from the emission means on the basis of the offset amount.

In order to solve the above problem, the invention according to claim 5 relates to a light beam emission control program that controls a light intensity level of different kinds of light beams emitted from emission means, by a computer,

which makes the computer function as:

emission control means for making the different kinds of light beams be emitted from the emission means;

information acquisition means for making detecting means detect an output intensity level of the light beam emitted from the emission means, and acquiring the light intensity level of the light beam as detection information;

error detection means for detecting an error with respect to a target value of the intensity level of the emitted light beam on the basis of the acquired detection information;

correction means for deciding an offset amount on the basis of the error and a correction amount corresponding to the light beam; and

output control means for controlling the output intensity level of the light beam emitted from the emission means on the basis of the offset amount.

### BRIEF DESCRIPTION OF THE DRAWINGS

FIG. 1 is a block diagram showing the configuration of an optical pickup device according to an embodiment of the present invention.

FIG. 2 is a graph showing IP characteristics of laser beams based of kinds of laser beams.

FIGS. 3A and 3B are graphs showing IP characteristics that are changed due to the temperature change or aging deterioration of a predetermined laser beam.

FIG. 4 is a flowchart illustrating that a control unit adjusts an emission intensity level when an offset amount of an embodiment is fixed.

FIG. 5 is a flowchart illustrating that a control unit adjusts an emission intensity level when an offset amount of an embodiment is changed.

### DESCRIPTION OF REFERENCE NUMERALS AND SIGNS

100: OPTICAL PICKUP DEVICE
110: LASER OUTPUT CIRCUIT
120: PHOTODETECTOR
130: FIRST CONVERTING UNIT
140: ERROR CALCULATING UNIT
150: AMPLIFIER
160: ERROR DETECTING UNIT
170: OFFSET DECIDING UNIT
180: ADDING UNIT
190: SECOND CONVERTING UNIT
200: GAIN ADJUSTING UNIT
210: CONTROL UNIT

### BEST MODE FOR CARRYING OUT THE INVENTION

A preferred embodiment of the present invention will be described below with reference to drawings.

Meanwhile, an embodiment to be described below is an embodiment where a light beam output control device according to the present invention is combined with an optical disc recording/reproducing device for performing recording/reproduction of optical recording media having different formats and is applied to an optical pickup device for emitting a predetermined laser beam. An optical recording medium will be described using optical discs, such as a CD, a DVD, and a BD.

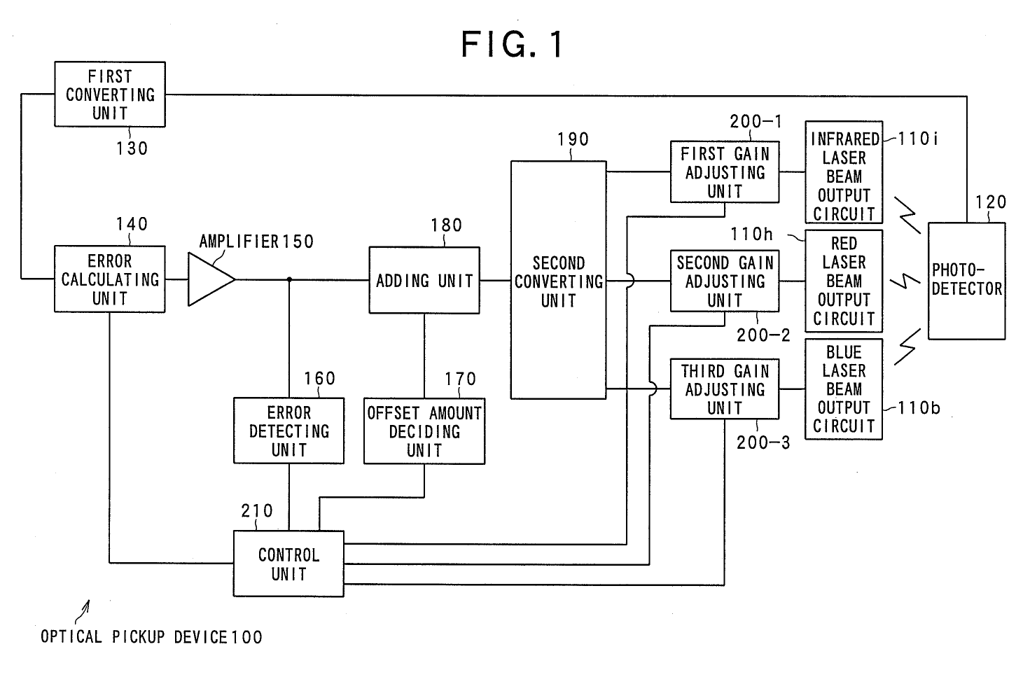

First, the configuration of an optical pickup device according to this embodiment will be described with reference to FIG. 1. Meanwhile, FIG. 1 is a block diagram showing the configuration of the optical pickup device according to this embodiment.

An optical pickup device 100 emits different light beams, such as an infrared laser beam, a red laser beam, and a blue laser beam, onto a CD, a DVD, or a BD. Further, the optical pickup device converts the intensity of the emitted light beam into a voltage, and detects the voltage. Furthermore, the optical pickup device changes a correction amount, which is used to correct corresponding error for each kind of the laser beams on the basis of the detected voltage (herein after, referred to as a “detection voltage”) of the light beam. Then, the optical pickup device performs a negative feedback control for the intensity level of each of the emitted laser beams.

In particular, the optical pickup device 100 according to this embodiment calculates an error between the detection voltage and a target value of each kind of the detected laser beams. If the calculated error is not in a predetermined range for each kind of the laser beams, the optical pickup device makes each kind of the laser beams correspond to the error and changes the correction amount of the error, that is, corrects the error on the basis of the correction amount corresponding to each kind of the laser beams, thereby performing a negative feedback control.

Accordingly, the optical pickup device 100 according to this embodiment can radiate appropriately corresponding laser beam at an intensity level that is used to perform a recording on optical recording media having different formats (herein after, referred to as a “recording intensity level”), or at an intensity level that is used to perform erasure thereon (herein after, referred to as an “erasing intensity level”).

Meanwhile, the “recording intensity level” means an energy amount that makes phase change or pigment discoloration occur on a phase change optical disc, for example, a CD-RW (CD-ReWritable) or a DVD-RW (DVD-ReWritable) disc and a pigment discoloration optical disc, for example, a CD-R (CD-Recordable) or a DVD-R (DVD-Recordable). Further, the “erasing intensity level” means an energy amount that makes phase change occur on a phase change optical disc and makes a crystallized phase change film amorphous. Furthermore, a reproducing intensity level to be described below means an energy amount that is used to read out recorded data without the change such as the pigment discoloration on an optical disc.

As shown in FIG. 1, the optical pickup device 100 includes an infrared laser beam output circuit 110i, a red laser beam output circuit 110r, a blue laser beam output circuit 110b, a photodetector 120, and a first converting unit 130. The infrared laser beam output circuit emits an infrared laser beam, which is used to perform the recording (herein after, also including “overwriting”) and reproduction of data, onto an optical disc. Likewise, the red laser beam output circuit emits a red laser beam onto an optical disc. Likewise, the blue laser beam output circuit emits a blue laser beam onto an optical disc. The photodetector detects a part of the emitted laser beams, and outputs current (herein after, referred to as “detection current”) on the basis of the detected laser beam. The first converting unit converts the detection current into a detection voltage value.

The optical pickup device 100 further includes an error calculating unit 140, an amplifier 150, an error detecting unit 160, an offset amount deciding unit 170, an adding unit 180, a second converting unit 190, gain adjusting units 200, and a control unit 210. The error calculating unit calculates an error (herein after, referred to as a “residual error”) on the basis of a target value predetermined for each kind of the detected laser beams. The amplifier amplifies the calculated error to a predetermined level. The error detecting unit detects the amplified error. The offset amount deciding unit decides a correction amount (herein after, referred to as an “offset amount”), which is used to correct an error on the basis of the detected error and each kind of the emitted laser beams. The adding unit adds the offset amount to the amplified error. The second converting unit converts the error, to which the offset amount is added, into current (herein after, referred to as “control current”) that is used to control each of the laser beam output circuits 110. The gain adjusting units adjust gains for each kind of the laser beams with respect to the converted control current. The control unit controls each of them.

Meanwhile, for example, the infrared laser beam output circuit 110i, the red laser beam output circuit 110r, and, the blue laser beam output circuit 110b of this embodiment form emission means, output control means, and emission control means of the present invention. The photodetector 120 forms beam detection means of the present invention. Further, for example, the error calculating unit 140 and the error detecting unit 160 of this embodiment form error detection means of the present invention, and the offset amount deciding unit 170 forms correction means and determination means of the present invention. In addition, for example, the adding unit 180 of this embodiment forms correction means of the present invention.

Each of the infrared laser beam output circuit 110i, the red laser beam output circuit 110r, and the blue laser beam output circuit 110b includes a semiconductor laser circuit that outputs corresponding kind of a laser beam, and controls the light intensity level of the output laser beam on the basis of the control current output from each of the gain adjusting units 200. Further, each of the laser beam output circuits emits the controlled laser beam onto an optical disc.

The photodetector 120 detects a part of the laser beam (for example, several % of the laser beams) output from the infrared laser beam output circuit 110i, the red laser beam output circuit 110r, or the blue laser beam output circuit 110b. Further, the photodetector generates current on the basis of the detected laser beam, and outputs the generated current to the first converting unit 130 as detection current.

The detection current generated by the photodetector 120 is input to the first converting unit 130. The first converting unit 130 converts the input detection current into a voltage, amplifies the voltage to a predetermined level, and outputs the converted voltage to the error calculating unit 140 as a detection voltage.

The detection voltage converted by the first converting unit 130 is input to the error calculating unit 140. The error calculating unit 140 has a target value predetermined for each kind of laser beams, calculates an error by comparing the input detection voltage with the target value of each kind of the detected laser beams under the control of the control unit 210.

Specifically, the error calculating unit 140 of this embodiment calculates an error by subtracting the input detection voltage from the target value of each kind of the detected laser beams, and outputs the calculated error to the error detecting unit 160 and the adding unit 180 through the amplifier 150.

The amplifier 150 is composed of an equalizer amplifier, adjusts a voltage level for each of predetermined frequency bands with respect to the input detection voltage, and outputs the adjusted detection voltage to the error detecting unit 160 and the adding unit 180. Meanwhile, the amplifier 150 is a controller for performing a negative feedback control, and more specifically, an amplifying circuit having integral characteristics.

The detection voltage, which is amplified to a predetermined voltage level, is input to the error detecting unit 160. The error detecting unit 160 outputs a detection voltage, which is detected in the control of the control unit 210 under a predetermined condition, for example, as described below on the basis of the laser beam emitted at a reproducing intensity level at a predetermined timing, as a detection voltage value.

Specifically, the error detecting unit 160 of this embodiment is operated together with any one laser beam output circuit 110 of the infrared laser beam output circuit 110i, the red laser beam output circuit 110r, and the blue laser beam output circuit 110b. When an error of the laser beam, which has the reproducing intensity level and is output from the laser beam output circuit 110 at a predetermined timing, is detected, the error detecting unit outputs the detection voltage corresponding to the detected error to the control unit 210 as a detection voltage value.

The offset amount deciding unit 170 decides an offset amount on the basis of the detection voltage value, which is detected by the error detecting unit 160 in the control of the control unit 210 under a predetermined condition, and the each kind of the laser beams detected by the photodetector 120. Further, the offset amount deciding unit outputs the decided offset amount to the adding unit 180.

Meanwhile, the operation of the offset amount deciding unit 170 of the embodiment and the principle of operation thereof will be described in detail below.

The error output from the amplifier 150 and the offset amount output from the offset amount deciding unit 170 are input to the adding unit 180. The adding unit 180 adds the offset amount to the input error under the control of the control unit 210 in order to correct the error. Further, the adding unit outputs the corrected error (herein after, referred to as a “correction error”) to the second converting unit 190.

The correction error output from the adding unit 180 is input to the second converting unit 190. The second converting unit 190 converts the input correction error from a voltage into current, and outputs the current (herein after, referred to as “control current”) representing the converted correction error to each of the gain adjusting units 200.

Each of the gain adjusting units 200 adjusts a gain of the control current, which is input according to each kind of the output laser beams, to a predetermined value under the control of the control unit 210. Further, each of the gain adjusting units outputs the control current, of which gain is adjusted, to corresponding laser beam output circuit 110. Meanwhile, only when each of the gain adjusting units 200 outputs corresponding laser beam, each of the gain adjusting units 200 outputs the control current to corresponding laser beam output circuit 110 while adjusting the gain.

The control unit 210 performs an emission intensity level adjusting process for controlling each of the units so that corresponding laser beam is emitted while a negative feedback control is performed with respect to corresponding laser beam on the basis of the kind of the laser beam decided according to the kind of the optical disc, which is recognized by a disc recognizing unit (not shown) and a laser beam is emitted thereon, and an error value detected by the error detecting unit 160.

In particular, while emitting a laser beam output from corresponding laser beam output circuit 110 at the reproducing intensity level, the control unit 210 of this embodiment decides an offset amount in the offset amount deciding unit 170 on the basis of the kind of the laser beam decided according to the kind of the optical disc or on the basis of the kind of corresponding laser beam and the error detected by the error detecting unit. Further, the control unit performs a process for setting a gain of corresponding gain adjusting unit 200 as the emission intensity level adjusting process on the basis of the kind of the laser beam detected according to the kind of the optical disc. Meanwhile, the operation of the emission intensity level adjusting process, which is performed by the control unit 210 according to this embodiment, will be described in detail below.

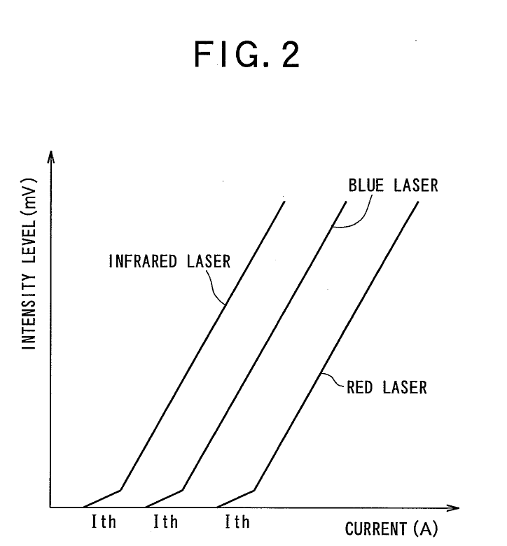

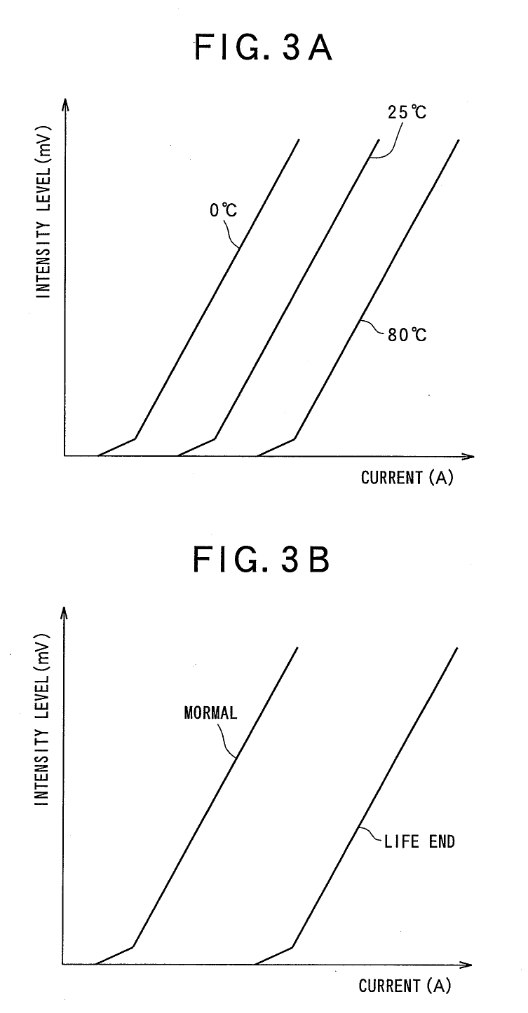

The operation of the offset amount deciding unit 170 of the embodiment and the principle of operation thereof will be described below with reference to FIGS. 2, and 3A and 3B. FIG. 2 is a graph showing IP characteristics of laser beams based of kinds of laser beams, and FIGS. 3A and 3B are graphs showing IP characteristics that are changed due to the temperature change or aging deterioration of a predetermined laser beam.

The offset amount deciding unit 170 of this embodiment decides an offset amount that corresponds to the detection voltage value detected by the error detecting unit 160 and the kind of the laser beam recognized by the disc recognizing unit (not shown), that is, an offset amount that is required to adequately perform a negative feedback control (APC) for each kind of the laser beams.

In general, a current-light intensity level characteristic of laser (IP characteristic) is changed due to operation temperature or aging deterioration, and the change of the characteristics varies for every laser beam. That is, as temperature rises, or as a period of use passes, required current varies even though a laser beam is emitted at the same intensity level. For example, an IP characteristic of a red laser beam is changed due to temperature as shown in FIG. 3A. Further, for example, an IP characteristic of a blue laser beam is changed due to aging deterioration as shown in FIG. 3B. Accordingly, the variation range (dynamic range that varies numerically) of the residual error needs to be set for each kind of the laser beams so that a negative feedback control is adequately performed, that is, an APC is adequately performed.

Meanwhile, the variation range of the residual error may be set to be applied to all of the laser beams. However, if the dynamic range of the detected variation error is set to be wide, a conversion gain before A/D conversion needs to be decreased when a digital control is performed. Specifically, the conversion gain of the first converting unit 130 needs to be decreased.

In this case, if the bit length of the A/D conversion is not increased, a quantization error is increased. If the bit length of the A/D conversion is increased, the area of an LSI chip is increased. For this reason, cost is increased, which is not preferable. Further, if the quantization error is increased, a control amount is changed stepwise, which is not preferable. In particular, when an analog control is performed, an S/N ratio during the detection of an error is decreased and it is easily affected by some noise. For this reason, it is difficult to reliably control an output intensity level of the laser beam. That is, if an input dynamic range of the error detecting unit 140 used as a detector for corresponding variation error is set to be wide when a source voltage supplied to the error detecting unit 140 is constant, the conversion gain of the first converting unit 130 is decreased. If an external noise component N of the input of the error detecting unit 140 is constant, the level of the error signal component S of the input is decreased as much as the input dynamic range is widened. As a result, the S/N ratio during the detection of an error is decreased.

Meanwhile, when a linear input voltage range of the error calculating unit 140 is in the range of 1 to 4 V, a laser emission intensity corresponding to a linear input voltage of 1 V is L mW, and a laser emission intensity corresponding to a linear input voltage of 4 V is H mW, the input dynamic range of the error detecting unit 140 corresponds to H-L mW.

In general, since the first converting unit 130 is formed on an optical pickup and the error calculating unit 140 is composed of a signal processing board, the first converting unit and the error calculating unit are connected to each other by a flexible cord. Accordingly, an external noise is penetrated through the flexible cord of the connection portion therebetween. If the flexible cord is shielded in order to remove the noise, cost is increased. Further, if being shielded, the flexible cord is hardened and the optical pickup is thus difficult to be driven. For this reason, even though it is understood that the flexible cord provided between the optical pickup and the signal processing board is affected by the external noise, the flexible cord cannot be shielded and the conversion gain of the first converting unit 130 needs to be maintained as high as possible.

The offset amount deciding unit 170 of this embodiment decides offset amounts, which are previously stored in the offset amount deciding unit, for the kinds of the emitted laser beams. Alternatively, offset amount deciding unit stores offset amounts therein for each kind of the emitted laser beams; discriminates whether the error detected by the error detecting unit 160 is in a predetermined range on the basis of the data representing the predetermined range; and decides an offset amount on the basis of the discrimination result. Even though an input dynamic range during the detection of the variation error is set to be narrow, it is possible to detect a residual error applicable to all of the laser beams. As a result, product cost is reduced, and it is possible to adequately perform a negative feedback control with respect to different light beams.

Specifically, the offset amount deciding unit 170 of this embodiment uses an offset amount fixing method in which an offset amount is decided to a predetermined fixed value, and an offset amount varying method in which an offset amount is appropriately changed and decided on the basis of an error varying according to operation.

### (Offset Amount Fixing Method)

In the case of an offset amount fixing method, the offset amount deciding unit 170 of this embodiment previously stores offset amounts for the kind of optical discs, and decides one offset amount stored therein on the basis of the kind of the discriminated optical disc.

### (Offset Amount Varying Method)

In the case of an offset amount varying method, an error is detected on the basis of emitted laser under a predetermined condition, for example, the laser beam emitted at the reproducing intensity level. The offset amount deciding unit 170 of this embodiment discriminates whether the error is in a range in which the error is expected to vary (herein after, simply referred to as a “variation range”) by using the above-mentioned data. Further, if the offset amount deciding unit discriminates that the detected error is not in the variation range, the offset amount deciding unit discriminates whether the error is in a range in which a negative feedback control can be adequately performed (herein after, simply referred to as a “numerical range”). Then, the offset amount deciding unit decides an offset amount on the basis of the discrimination result.

That is, according to this embodiment, if the detected error is not in the variation range and not in the numerical range, the detected error exists in the vicinity of a lower limit or an upper limit of the range in which the detected error varies. Therefore, after that, there may be a case that a control cannot be performed in the negative feedback control due to an error serving as the reference of the negative feedback control (an error calculated by the error calculating unit 140 when the negative feedback control is performed). Therefore, the offset amount deciding unit 170 of this embodiment decides an offset amount where a negative feedback control can be adequately performed for each kind of the emitted laser beams, that is, for every set variation range.

In more detail, if the detected error is in a predetermined variation range corresponding to the kind of the emitted laser beam, the offset amount deciding unit 170 of this embodiment decides an offset amount to “0” on the basis of the kind of the emitted laser beam. If the detected error is not in a predetermined variation range, the offset amount deciding unit discriminates whether the error is in the numerical range. If the error is not in the numerical range, the offset amount deciding unit adds a predetermined value to the present offset amount. If the error is in the numerical range, the offset amount deciding unit subtracts a predetermined value from the present offset amount. In this way, the offset amount deciding unit decides an offset amount.

Meanwhile, the predetermined value may be appropriately set for each kind of the laser beams so that the error is in the numerical range.

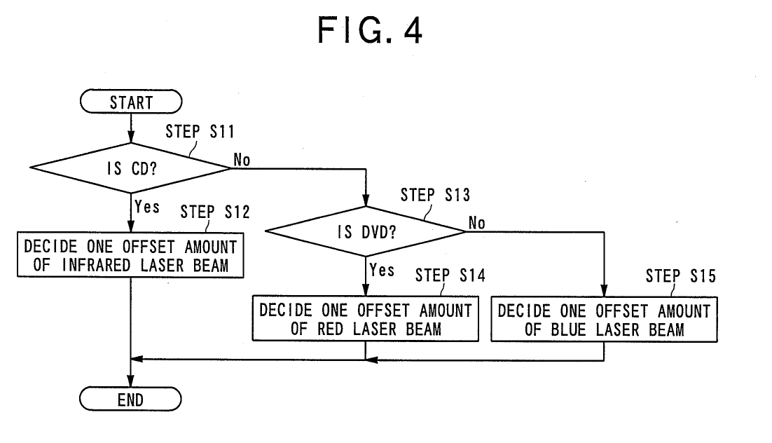

The emission intensity level adjusting process of the control unit 210 in the offset amount fixing method of this embodiment will be described below with reference to FIG. 4. Further, FIG. 4 is a flowchart illustrating that the control unit 210 adjusts an emission intensity level in the fixing method of this embodiment.

In the following description, the optical disc has been already loaded in the optical disc recording/reproducing device (not shown), and the kind of the loaded optical disc has been already recognized by the disc recognizing unit (not shown). Further, when the optical disc is loaded in the optical disc recording/reproducing device or when recording/reproduction is performed on the optical disc, this operation is performed at a predetermined timing. In addition, the offset amount of the APC is the difference between current Ith of a laser beam that is the reference, for example, the standard control current of a blue laser beam, and current Ith of a laser beam having a different wavelength.

First, the control unit 210 discriminates whether the kind of the loaded optical disc or the optical disc rotating for recording/reproduction is a CD on the basis of the result of the discrimination of the optical disc that is performed by the disc recognizing unit (not shown) (Step S11).

In this case, if the control unit discriminates that the kind of the loaded optical disc or the optical disc rotating for recording/reproduction is a CD, the control unit 210 controls the first gain adjusting unit 200 and decides an offset amount of the infrared laser beam (Step S12). Then, control unit terminates this operation.

Meanwhile, if the control unit discriminates that the kind of the loaded optical disc or the optical disc rotating for recording/reproduction is not a CD, the control unit 210 discriminates whether the optical disc is a DVD disc (Step S13).

Then, if the control unit 210 discriminates that the kind of the loaded optical disc or the optical disc rotating for recording/reproduction is a DVD in the process of Step S13, the control unit 210 controls the second gain adjusting unit 200 and decides an offset amount of the red laser beam (Step S14). After that, the control unit terminates this operation.

Meanwhile, if the control unit 210 discriminates that the kind of the loaded optical disc or the optical disc rotating for recording/reproduction is not a DVD, the control unit discriminates whether the optical disc is a BD, controls the third gain adjusting unit 200 and decides an offset amount of the blue laser beam (Step S15). Then, the control unit terminates this operation.

When the offset amount is decided by the offset amount deciding unit 170 in this way in this embodiment, an error is adjusted on the basis of the decided offset amount during the negative feedback control from the offset amount deciding unit 170 and the current Ith is input to corresponding gain adjusting unit 200 on the basis of the adjusted error. Therefore, it is possible to adequately perform a negative feedback control. As a result, it is possible to adequately emit a laser beam.

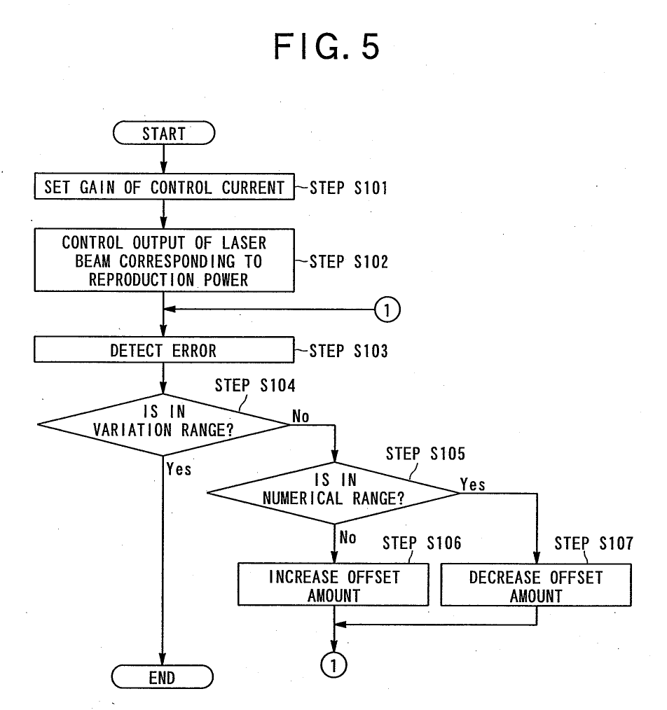

The emission intensity level adjusting process of the control unit 210 in the offset amount varying method of this embodiment will be described below with reference to FIG. 5. Further, FIG. 5 is a flowchart illustrating that the control unit 210 adjusts an emission intensity level in the offset amount varying method of this embodiment.

In the following description, the optical disc has been already loaded in the optical disc recording/reproducing device (not shown), and the kind of the loaded optical disc has been already recognized by the disc recognizing unit (not shown). Further, when the optical disc is loaded in the optical disc recording/reproducing device or when recording/reproduction is performed on the optical disc, this operation is performed at a predetermined timing.

First, the control unit 210 discriminates the kind of the loaded optical disc or the optical disc rotating for recording/reproduction, controls corresponding gain adjusting unit 200 on the basis of the discriminated kind of the optical disc, and sets a gain of control current to be input (Step S101). Specifically, if the discriminated optical disc is a CD, the control unit 210 sets a gain of the first gain adjusting unit 200. If the discriminated optical disc is a DVD or a BD, the control unit 210 sets a gain of the second gain adjusting unit 200 or the third gain adjusting unit.

Then, the control unit 210 controls the gain adjusting unit 200, that is, an object to be controlled, and controls corresponding laser beam output circuit 110 so that a laser beam is emitted at the reproducing intensity level (Step S102). Specifically, if the discriminated optical disc is a CD, the control unit 210 controls the infrared laser beam output circuit 110i so that an infrared laser beam is emitted through the first gain adjusting unit 200 at the reproducing intensity level. If the discriminated optical disc is a DVD, the control unit 210 controls the red laser beam output circuit 110r so that a red laser beam is emitted through the second gain adjusting unit 200 at the reproducing intensity level. Further, if the discriminated optical disc is a BD, the control unit 210 controls the blue laser beam output circuit 110b so that a blue laser beam is emitted through the third gain adjusting unit 200 at the reproducing intensity level.

After that, the control unit 210 makes the error detecting unit 160 detect the error that is calculated by the error calculating unit 140 (Step S103), and makes the offset amount deciding unit 170 discriminate whether the error is in a predetermined variation range on the basis of the discriminated optical disc (Step S104).

Specifically, if the offset amount deciding unit 170 discriminates that the optical disc is a CD in the process of Step S104, that is, if the emitted laser beam is an infrared laser beam, the offset amount deciding unit 170 discriminates whether the detected error, for example, the output (APC error) of the amplifier 150 is within the range of the center value of the dynamic range +20% to the center value of the dynamic range −20%. Further, if the optical disc is a DVD, that is, if the emitted laser beam is a red laser beam, the offset amount deciding unit 170 discriminates whether the detected error, for example, the output (APC error) of the amplifier 150 is within the range of the center value of the dynamic range +10% to the center value of the dynamic range −10%. In addition, if the optical disc is a BD, that is, if the emitted laser beam is a blue laser beam, the offset amount deciding unit 170 discriminates whether, for example, the APC error is within the range of the center value of the dynamic range +20% to the center value of the dynamic range −20%. If the detected error is in the vicinity of the center value of the dynamic range as described above, for example, the operating current of the laser beam is increased when temperature rises and the operating current of the laser beam is decreased when temperature falls. Therefore, it is possible to adequately perform a negative feedback control.

In the case of a DVD, the current Ith of a red laser beam is significantly changed due to temperature, so that an adjustment error becomes small. Accordingly, unlike other optical discs, an error range is set to be small. Further, if it is discriminated that the detected error is in a predetermined variation range on the basis of the discriminated optical disc in Step S104, the control unit 210 terminates this operation.

Meanwhile, if the offset amount deciding unit 170 discriminates that the detected error is not in a predetermined variation range on the basis of the discriminated optical disc in the process of Step S103, the control unit 210 makes the offset amount deciding unit 170 discriminate whether the detected error is in a predetermined numerical range on the basis of the discriminated optical disc (Step S105).

For example, like the process of Step S104 for comparing the detected error with the numerical range, the offset amount deciding unit 170 compares the detected error with a numerical range of corresponding laser beam when the optical disc is a CD, a DVD, or a BD, and discriminates whether the error is in the numerical range. Further, for example, the numerical range is appropriately set for each kind of the laser beams.

Then, if the offset amount deciding unit 170 discriminates that the detected error is not in a predetermined numerical range on the basis of the discriminated optical disc in the process of Step S105, the control unit 210 makes the offset amount deciding unit 170 add a predetermined value to the offset amount and decide an offset amount (Step S106). After that, the process proceeds to Step S103.

Meanwhile, if the offset amount deciding unit 170 discriminates that the detected error is in a predetermined numerical range on the basis of the discriminated optical disc, the control unit 210 makes the offset amount deciding unit 170 subtract a predetermined value from the offset amount and decide an offset amount. After that, the process proceeds to Step S103.

The optical pickup device 100 according to this embodiment is an optical pickup device 100 that performs an emission control of different kinds of light beams. The optical pickup device includes the laser beam output circuits 110 that emit different kinds of light beams, the photodetector 120 that detects at least a part of the light beams emitted from the laser beam output circuits 110, the error calculating unit 140 and the error detecting unit 160 that detect errors with respect to target values of the intensity levels of the emitted light beams on the basis of the detected light beams, and the offset amount deciding unit 170 and the adding unit 180 that correct the detected errors on the basis of the kinds of the laser beams. The laser beam output circuits 110 control the output intensity levels of the light beams emitted from the laser beam output circuits 110 on the basis of the corrected errors. The offset amount deciding unit 170 and the adding unit 180 change a correction amount, which is used when the errors are corrected on the basis of the kinds of the light beams.

By virtue of this configuration, the optical pickup device 100 according to this embodiment changes the correction amount, which is used when the errors are corrected on the basis of the kinds of the light beams, and performs the correction of the detected errors on the basis of the changed correction amount. Therefore, it is possible to perform the correction by using simple configuration, and to adequately perform a negative feedback control for each of different light beams. As a result, it is possible to reduce product cost, and to appropriately radiate laser beams onto optical discs having different record formats when data is recorded.

Further, in the optical pickup device 100 according to this embodiment, the offset amount deciding unit 170 and the adding unit 180 correct the detected error on the basis of the correction amount that is predetermined for each kind of the light beams. Accordingly, it is possible to easily perform the correction of different light beams, and to adequately perform a negative feedback control for each light beam.

Furthermore, in the optical pickup device 100 according to this embodiment, the offset amount deciding unit 170 determines whether the detected error is in the numerical range predetermined for each kind of the light beams. If the offset amount deciding unit determines that the detected error is not in the numerical range predetermined for each kind of the light beams, the offset amount deciding unit corrects the detected error on the basis of a predetermined correction amount. Accordingly, it is possible to adequately prevent the detected error from being out of the variation range during the negative feedback control after the offset amount is decided.

In this embodiment, the detected error have been compared with the variation range and the numerical range for each kind of corresponding laser beam in order to decide the offset amount. However, the error may be compared with the only variation range or the only numerical range in order to decide the offset amount.

Further, a laser beam, which is used for a CD, a DVD, or a BD, has been used as the light beam in this embodiment. However, a laser beam, which is used to perform a recording or a reproduction on another optical recording medium such as a HDDVD, may be used as the light beam.

Furthermore, the offset amount has been added to the voltage of the detected error in this embodiment. However, the offset amount may be added to the current that is converted from the detected voltage, that is, the control current. In this case, the offset amount deciding unit 170 decides the offset amount in the form of a current value.

In this embodiment, the offset amount deciding unit 170 may detect the difference between the detected error and the center value of the variation range, and decide the offset amount on the basis of the detected difference (Step S106 and Step S107) Therefore, the detected error is corrected using a predetermined correction amount in order to make the detected error be the center value of the variation range of the error for each kind of the light beams. As a result, it is possible to adequately prevent the detected error from being out of the variation range during the negative feedback control after the offset amount is decided. One offset amount may be calculated by not performing the determination in the numerical range, and then added.

Further, the control unit 210 has decided the offset amount and adjusted the emission intensity level in this embodiment. However, a computer and a recording medium are provided in the optical pickup device 100, which includes the laser beam output circuits for emitting laser beams. Then, a control program, which executes the above-mention offset amount deciding process and emission intensity level adjusting process, is stored in the recording medium. After that, the same offset amount deciding process and emission intensity level adjusting process as described above may be performed by reading out the control program with the computer.

The disclosure of Japanese Patent Application (No. 2005-262226) including the specification, claims, drawings, and abstract, which was filed on Sep. 9, 2005 is incorporated herein by reference in its entirety.

1. A light beam output control device, which performs an emission control of different kinds of light beams, the device comprising:
an emission device which emits the different kinds of light beams;
a beam detection device which detects an output intensity level of the light beam emitted from the emission device;
an error detection device which detects an error between the detected output intensity level of the light beam and a target value;
a correction device which decides an offset amount on the basis of the error and a correction amount corresponding to each kind of the light beams; and
an output control device which controls the output intensity level of the light beams emitted from the emission device on the basis of the offset amount.

2. The light beam output control device according to claim 1,
wherein the correction device corrects the detected error on the basis of the correction amount predetermined for each kind of the light beams.

3. The light beam output control device according to claim 1,
wherein the correction device calculates the correction amount that makes the detected error to be at the center of a variation range of the error for each kind of the light beams, and corrects the detected error by using the calculated correction amount.

4. The light beam output control device according to claim 1, further comprising:
a determination device which determines whether the detected error is in a numerical range predetermined for each kind of the light beams,
wherein if the determination device means determines that the detected error is not in the numerical range predetermined for each kind of the light beams, the correction device changes the correction amount in order to correct the detected error.

5. A recording medium on which a light beam emission control program is recorded so as to be read out by a computer,
said program controlling a light intensity level of different kinds of light beams emitted from an emission device, and,
said program making the computer function as:
an emission control device which makes the different kinds of light beams be emitted from the emission device;
an information acquisition device which makes a detecting device detect an output intensity level of the light beam emitted from the emission device, and acquiring the light intensity level of the light beam as detection information;
an error detection device which detects an error with respect to a target value of the intensity level of the emitted light beam on the basis of the acquired detection information;
a correction device which decides an offset amount on the basis of the error and a correction amount corresponding to the light beam; and
an output control device which controls the output intensity level of the light beam emitted from the emission device on the basis of the offset amount.

6. (canceled)
